(19) United States
(12) Patent Application Publication
(10) Pub. No.: US 2018/0267659 A1
(43) Pub. Date: Sep. 20, 2018

(54) PRESSURE SENSING SUBSTRATE, PRESSURE SENSING PANEL, DISPLAY DEVICE AND PRESSURE DETECTION METHOD

(71) Applicants: BOE Technology Group Co., Ltd., Beijing (CN); Chengdu BOE Optoelectronics Technology Co., Ltd., Chengdu (CN)

(72) Inventors: Weiyun Huang, Beijing (CN); Yang Wang, Beijing (CN); Tingliang Liu, Beijing (CN)

(21) Appl. No.: 15/793,174

(22) Filed: Oct. 25, 2017

(30) Foreign Application Priority Data
Mar. 17, 2017 (CN) 201710163809.X

(51) Int. Cl. G06F 3/041; G06F 3/044

(52) U.S. Cl. CPC G06F 3/0414; G06F 2203/04112; G06F 3/044; G06F 3/0412

(57) ABSTRACT

The embodiments of the present disclosure provide a pressure sensing substrate, a pressure sensing panel, a display device and a pressure detection method. The pressure sensing substrate includes a plurality of sensing units, each of the sensing units including a pressure electrode and a plurality of coordinate electrodes, wherein an orthographic projection of the plurality of coordinate electrodes onto a preset base substrate is surrounded by an orthographic projection of the pressure electrode onto the preset base substrate, and the pressure electrode and the plurality of coordinate electrodes are configured to identify a pressure magnitude and a touch position on the pressure sensing substrate by sensing change values of capacitance on the pressure electrode and the plurality of coordinate electrodes.

### CROSS-REFERENCE TO RELATED APPLICATION

This application claims the benefit of Chinese Patent Application No. 201710163809.X filed on Mar. 17, 2017 in the State Intellectual Property Office of China, the disclosure of which is incorporated in entirety herein by reference.

### BACKGROUND

### Technical Field

Embodiments of the present disclosure relate to a field of display technology, and more particularly, to a pressure sensing substrate, a pressure sensing panel, a display device and a pressure detection method.

### Description of the Related Art

Pressure touch technology is one kind of new technology, by which a pressure sensing device is provided at an edge of a display module to perceive a user's pressing operation and thus to realize different operations and menu calls according to different values of perceived pressure. For example, pressure sensors may be arranged at four corners of a display screen, and the different pressing forces may be qualified to three levels of action, “light press, press, heavy press”, to implement feedback. Through the pressure touch technology, it allows a touch interaction to extend from a “time” dimension of the pressing to an “intensity” dimension of the pressing, thereby gives a human-computer interaction a fully new development space. Therefore, the pressure touch technology is more and more favored by the industry and the users.

At present, it is necessary for the conventional pressure touch technology to incorporate a stress layer or a pressure sensor, thereby increasing a thickness of a panel, risk in a manufacturing process and manufacturing cost of the panel.

### SUMMARY

An embodiment of the present disclosure discloses a pressure sensing substrate, comprising a plurality of sensing units, each of the sensing units comprising a pressure electrode and a plurality of coordinate electrodes, wherein an orthographic projection of the plurality of coordinate electrodes onto a preset base substrate is surrounded by an orthographic projection of the pressure electrode onto the preset base substrate, and the pressure electrode and the plurality of coordinate electrodes are configured to identify a pressure magnitude and a touch position on the pressure sensing substrate by sensing change values of capacitance on the pressure electrode and the plurality of coordinate electrodes.

Optionally, the pressure electrode is disposed in a same layer as the plurality of coordinate electrodes, and the pressure electrode is configured to surround the plurality of coordinate electrodes and the pressure electrode is arranged independently relative to the plurality of coordinate electrodes.

Optionally, the pressure electrode is disposed in a different layer from a layer where the plurality of coordinate electrodes are located, and the pressure electrode and the plurality of coordinate electrodes are separated by an insulation layer.

Optionally, the coordinate electrodes are rectangular or circular.

Optionally, the pressure electrode and the plurality of coordinate electrodes are configured to be driven in a simultaneous manner or in a time-division manner.

Optionally, the pressure sensing substrate further comprises a plurality of common electrodes, wherein the pressure electrode and the plurality of coordinate electrodes are configured to reuse the plurality of common electrodes.

Optionally, each of the sensing units comprises a plurality of pressure electrodes and the plurality of coordinate electrodes.

Optionally, the coordinate electrodes are configured to identify the touch position on the pressure sensing substrate, and the pressure electrode is configured to identify the pressure magnitude on the pressure sensing substrate.

An embodiment of the present disclosure discloses a pressure sensing panel, comprising the pressure sensing substrate according to any one of the above embodiments.

Optionally, the coordinate electrodes on the pressure sensing substrate are independently arranged relative to each other, and

the coordinate electrodes are electrically connected to a position sensing chip, respectively; or the plurality of coordinate electrodes are connected to each other and the connected coordinate electrodes are electrically connected to the position sensing chip.

Optionally, the pressure electrodes on the pressure sensing substrate are independently arranged relative to each other, and

the pressure electrodes are electrically connected to a pressure sensing chip, respectively; or the plurality of pressure electrodes are connected to each other and the connected pressure electrodes are electrically connected to the pressure sensing chip.

An embodiment of the present disclosure discloses a display device, comprising the pressure sensing panel according to any one of the above embodiments.

An embodiment of the present disclosure discloses a pressure detection method, comprising steps of:

receiving a user's touch operation on a pressure sensing substrate, the pressure sensing substrate comprising a plurality of sensing units, each sensing unit comprising a pressure electrode and a plurality of coordinate electrodes, and an orthographic projection of the plurality of coordinate electrodes onto a preset base substrate being surrounded by an orthographic projection of the pressure electrode onto the preset base substrate;

obtaining change values of capacitance on the pressure electrode and the plurality of coordinate electrodes; and

identifying a pressure magnitude and a touch position on the pressure sensing substrate based on the change values of capacitance.

Optionally, the step of identifying the pressure magnitude and the touch position on the pressure sensing substrate based on the change values of capacitance comprises:

determining a position of the coordinate electrode whose capacitance has changed;

identifying the touch position on the pressure sensing substrate according to the position;

determining a change value of capacitance on the pressure electrode corresponding to the touch position; and

identifying the pressure magnitude on the pressure sensing substrate according to the change value of capacitance on the pressure electrode.

Optionally, the step of identifying the pressure magnitude on the pressure sensing substrate according to the change value of capacitance on the pressure electrode comprises:

calculating the pressure magnitude according to a direct proportional relationship between the change value of capacitance on the pressure electrode and the pressure magnitude.

### BRIEF DESCRIPTION OF THE DRAWINGS

FIG. 1 is a schematic diagram of a pressure touch technology in the related art;

FIG. 2 is a schematic view of a pressure sensing substrate according to an embodiment of the present disclosure;

FIG. 3 is a schematic view of circular coordinate electrodes according to an embodiment of the present disclosure;

FIG. 4 is a schematic view showing change values of capacitance on coordinate electrodes according to an embodiment of the present disclosure;

FIGS. 5A-5B are schematic views of pressing modes according to an embodiment of the present disclosure;

FIGS. 6A-6B are schematic views showing change values of capacitance on a pressure electrode according to an embodiment of the present disclosure;

FIG. 7 is a schematic view showing a connection of coordinate electrodes according to an embodiment of the present disclosure; and

FIG. 8 is a flow chart for showing steps of a pressure detection method according to an embodiment of the present disclosure.

### DETAILED DESCRIPTION OF PREFERRED EMBODIMENTS

In order to make clear the above objectives, features and advantages of the present disclosure, the present disclosure will be further described in detail with reference to the accompanying drawings and specific embodiments.

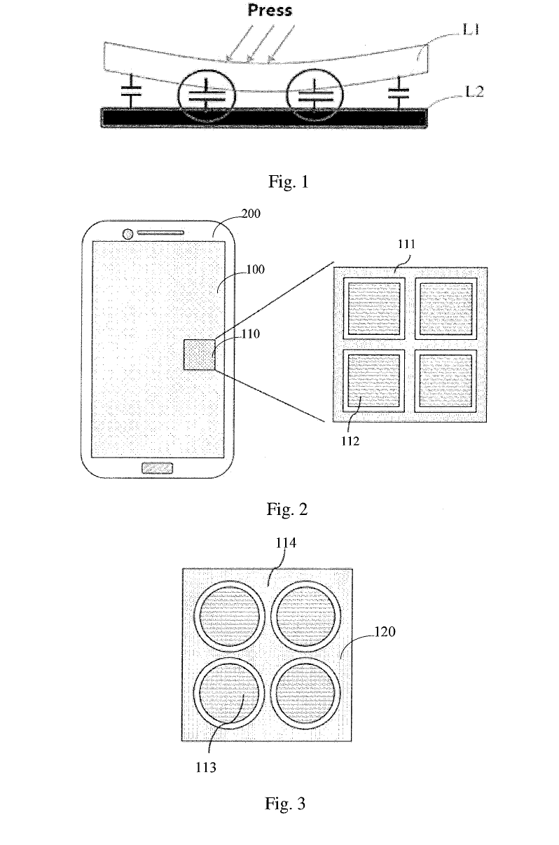

Pressure touch technology can be carried out in two modes, i.e., a sensing touch or a capacitive touch. As shown in FIG. 1, which is a schematic diagram of a pressure touch technology in the related art, a capacitive touch mode therein is adopted to achieve a perception of a pressure value or pressing strength, i.e., a stress layer L1 is added. Once a pressure on the stress layer L1 changes, a capacitance between the stress layer L1 and a reference layer L2 will change, thereby a change of pressure can be detected by a change amount of the capacitance. On the other hand, if a sensing touch mode is adopted, then it is necessary to incorporate a pressure sensor on a panel. Therefore, no matter which mode is adopted, since the stress layer or the pressure sensor is incorporated, the thickness of the panel is accordingly increased, thereby increasing the risk in the manufacturing process and the manufacturing cost of the panel.

In view of the above problems, the embodiments of the present disclosure are proposed to provide a pressure sensing substrate, a pressure sensing panel, a display device and a pressure detection method for overcoming the above problems or at least partially solving the above problems.

As shown in FIG. 2, which is a schematic view of a pressure sensing substrate according to an embodiment of the present disclosure, the pressure sensing substrate 100 can be applied to a terminal 200, for example a mobile terminal such as a mobile phone, a tablet computer, a smart watch, or other electronic devices which can be operated by touch, for example, a smart television, a smart telephone. The specific types of the terminal 200 are not limited in the embodiments of the present disclosure.

In an embodiment of the present disclosure, the pressure sensing substrate 100 may include a plurality of sensing units 110, for example, patterns may be generated by exposure, developing, etching or the like, and the patterns may be used as the sensing units 110. Each sensing unit 110 may further include a pressure electrode 111 and a plurality of coordinate electrodes 112.

In an embodiment of the present disclosure, an orthographic projection of the plurality of coordinate electrodes 112 onto a preset base substrate may be surrounded by an orthographic projection of the pressure electrode 111 onto the preset base substrate, and the pressure electrode and the plurality of coordinate electrodes are configured to identify a pressure magnitude and a touch position on the pressure sensing substrate 100 by sensing change values of capacitance on the pressure electrode 111 and the plurality of coordinate electrodes 112.

Specifically, the pressure electrode 111 may be disposed in the same layer as the plurality of coordinate electrodes 112, and the pressure electrode 111 may surround the plurality of coordinate electrodes 112 and the pressure electrode 111 may be arranged independently relative to the plurality of coordinate electrodes 112. Or alternatively, the pressure electrode 111 may be disposed in a different layer from a layer where the plurality of coordinate electrodes 112 are located. If the pressure electrode 111 is disposed in the different layer from that of the plurality of coordinate electrodes 112, the pressure electrode 111 and the plurality of coordinate electrodes 112 may be separated by an insulation layer.

In an embodiment of the present disclosure, no matter whether the pressure electrode 111 is disposed in the same layer as or the different layer from the layer where the plurality of coordinate electrodes 112 are located, the relative positional relationship between the pressure electrode 111 and the coordinate electrodes 112 may be determined in such a manner that the orthographic projection of the plurality of coordinate electrodes 112 onto the preset base substrate is surrounded by the orthographic projection of the pressure electrode 111 onto the preset base substrate.

In FIG. 2, the sensing unit 110 includes a pressure electrode 111 and four coordinate electrodes 112. The four coordinate electrodes 112 are respectively designed to be rectangular, and then they are arranged in four quarters, and the four coordinate electrodes 112 together with the pressure electrode 111 surrounding them form a sensing unit 110. Of course, the arrangement mode of the pressure electrode 111 and the coordinate electrodes 112 may be determined by those skilled in the art according to actual needs, for example, three coordinate electrodes 112 may be provided and the three coordinate electrodes 112 may be arranged in a pyramid shape. The arrangement mode will not be limited in the embodiments of the present disclosure.

In an embodiment of the present disclosure, the pressure electrode 111 surrounding the coordinate electrodes 112 may be of an integral structure, or may be divided into a plurality of small electrodes. Thus, each of the sensing units 110 may also include a plurality of pressure electrodes 111 and a plurality of coordinate electrodes 112, which will not be limited in the embodiments of the present disclosure.

In an example of the present disclosure, the coordinate electrode may also be designed to be circular, as shown in FIG. 3, which is a schematic view of circular coordinate electrodes according to an embodiment of the present disclosure. Similar to the rectangular coordinate electrodes 112 in FIG. 2, the four circular coordinate electrodes 113 in FIG. 3 may also be arranged in four quarters and they form a sensing unit 120 together with the pressure electrode 114 surrounding them.

It should be noted that, in practical applications, other shapes of coordinate electrode may be used by those skilled in the art in addition to the rectangular coordinate electrode 112 or the circular coordinate electrode 113, for example, a special-shaped coordinate electrode, which will not be limited in the embodiments of the present disclosure. Accordingly, the shape of the pressure electrode surrounding the coordinate electrodes can also be determined according to the specific shape of the coordinate electrodes, and it will not be limited in the embodiments of the present disclosure.

In general, both the pressure electrode 111 and the coordinate electrodes 112 need driving pulse to detect the change value of capacitance. Thus, in a particular implementation, the pressure electrode 111 and the plurality of coordinate electrodes 112 may be configured to be driven in a simultaneous manner or in a time-division manner.

The driving in the simultaneous manner may refer to the fact that the pressure electrode 111 and the coordinate electrodes 112 are simultaneously driven, while the driving in the time-division manner refers to the fact that the coordinate electrodes 112 are not driven when the pressure electrode 111 is driven, whereas the pressure electrode 111 is not driven when the coordinate electrodes 112 are driven.

It should be noted that since the number of the pressure electrode 111 is less than that of the coordinate electrodes 112, the pressure electrode 111 takes a relatively short time. Therefore, when the driving in the time-division manner is used, the driving of the coordinate electrodes 112 and the driving of the pressure electrode 111 need to be implemented one or more times in one same frame, so as to prevent mismatching of them due to too long time difference.

In general, the pressure sensing substrate 100 may also include a plurality of common electrodes. Thus, in a particular implementation, the pressure electrode 111 and the plurality of coordinate electrodes 112 may also be configured to reuse the plurality of common electrodes.

In an embodiment of the present disclosure, the coordinate electrodes 112 on the sensing unit 110 may be used to identify the touch position on the pressure sensing substrate 100, and the pressure electrode 111 may be used to identify the pressure magnitude on the pressure sensing substrate 100.

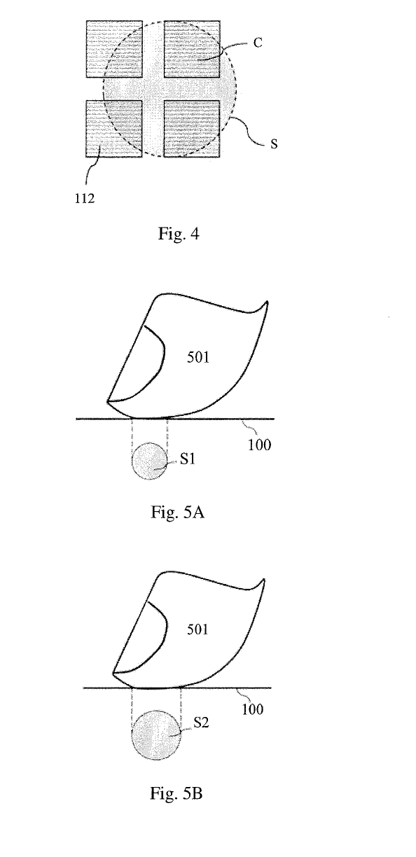

As shown in FIG. 4, which is a schematic view showing the change values of capacitance on the coordinate electrodes according to an embodiment of the present disclosure, a user performs a press or touch operation on a certain sensing unit 110, if a contact area S of the user with the sensing unit 110 is generated during the press or touch operation, then the coordinate electrode 112 on the sensing unit may accordingly generate a change value C of capacitance corresponding to the area S, thereby a specific position of the corresponding press or touch can be identified according to the change value C of capacitance. If the change value of capacitance is greater than 0 or a preset threshold value, then the region is pressed or touched. In this embodiment, as for the identification of the coordinate position of the press or touch, reference can be made to a self capacitive touch or a mutual capacitive touch in the related art, which will not be described herein.

In an embodiment of the present disclosure, the pressure electrode 111 on the sensing unit 110 may also generate a change value of capacitance corresponding to the above-described press or touch operation when the user performs the press or touch operation on a display screen, thereby the pressure magnitude of the press or touch operation can be identified according to the change value of capacitance.

In a particular implementation, the change value of capacitance on the pressure electrode 111 may be directly proportional to the pressure magnitude on the pressure sensing substrate 100.

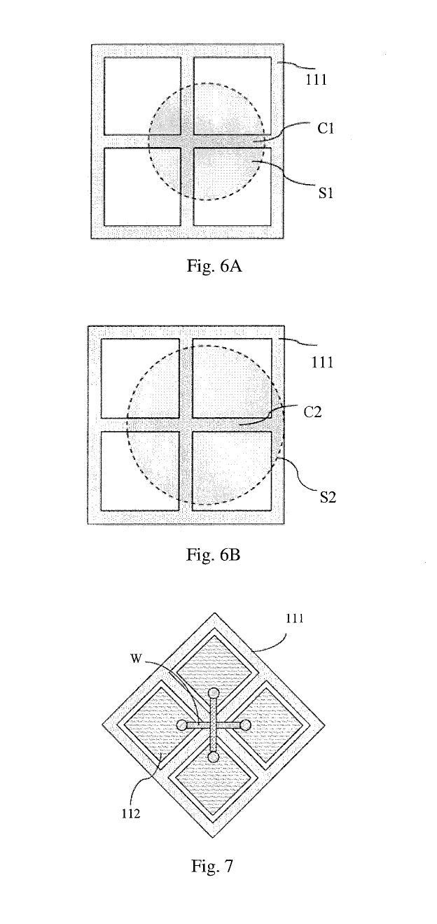

FIGS. 5A and 5B are schematic views of press modes according to an embodiment of the present disclosure. In FIG. 5A, the user presses the pressure sensing substrate 100 by a certain pressure, for example, a first pressure, and a contact area S1 between the user's finger 501 and the pressure sensing substrate 100 is generated during this operation. Referring to FIG. 6A, which is a schematic view showing the change value of capacitance on the pressure electrode according to an embodiment of the present disclosure, when the user presses the pressure sensing substrate 100 by the first pressure in a manner as shown in FIG. 5A, the change value C1 of capacitance on the pressure electrode 111 can be generated, as shown in FIG. 6A.

Similarly, in FIG. 5B, the user presses the pressure sensing substrate 100 by a pressure of another magnitude different from that of the first pressure, for example, a second pressure. During this operation, a contact area between the user's finger 501 and the pressure sensing substrate 100 is S2, the change value C2 of capacitance on the pressure electrode 111 can be generated, as shown in FIG. 6B.

The contact area S2 formed by the press of the user by the second pressure is greater than the contact area S1 formed by the press of the user by the first pressure, and accordingly, the change value C2 of capacitance generated on the pressure electrode 111 by the second pressure is greater than the change value C1 of capacitance generated on the pressure electrode 111 by the first pressure. According to the direct proportional relationship between the change value of capacitance on the pressure electrode 111 and the pressure magnitude on the pressure sensing substrate 100, since the first pressure is less than the second pressure, it is considered that the press operation by the first pressure is a light press and the press operation by the second pressure is a heavy press, thereby the terminal 200 can perform different operations depending on the pressure magnitude.

It should be noted that the above description is made only by taking the light press and the heavy press as an example. Actually, those skilled in the art can divide the pressure value or pressing strength of the user's press operation into more levels according to actual needs, which will not be limited in the embodiments of the present disclosure.

In the embodiments of the present disclosure, by providing a plurality of sensing units each including a pressure electrode and a plurality of coordinate electrodes on the pressure sensing substrate and providing that the orthographic projection of the plurality of coordinate electrodes onto the preset base substrate is surrounded by the orthographic projection of the pressure electrode onto the preset base substrate, the pressure magnitude and the touch position on the pressure sensing substrate can be identified by sensing the change values of capacitance on the pressure electrode and the plurality of coordinate electrodes. The embodiments of the present disclosure do not require the provision of a pressure sensor on the pressure sensing substrate, therefore the pressure sensor is removed, the supply chain is simplified, the risk ratio in the manufacturing process of the pressure sensing substrate and the manufacturing cost are reduced, the product yield of the pressure sensing substrate is increased.

Further, in the embodiments of the present disclosure, the coordinate electrodes and the pressure electrode are separately provided, the coordinate electrodes are used to identify the specific position of the press or touch operation, and the pressure electrode is used to identify the pressure magnitude of the press or touch operation. In contrast to the technical solution that only a coordinate electrode is used to identify both the position and the pressure, it has a higher pressure sensitivity and simpler data processing.

An embodiment of the present disclosure discloses a pressure sensing panel comprising the pressure sensing substrate 100 according to the above embodiments. Reference may be made to the description of the pressure sensing substrate 100 in the above embodiments, which will not be repeated in this embodiment.

In an embodiment of the present disclosure, a sensing chip may be provided in connection with the pressure electrode and the coordinate electrodes on the pressure sensing panel, the sensing chip may include a pressure sensing chip and a position sensing chip.

In particular, the coordinate electrodes each may be independently arranged relative to each other, and the coordinate electrodes are electrically connected to the position sensing chip, respectively, thus upon a receipt of an external touch or press operation the capacitance may be changed and then the change value of capacitance may be transmitted to the position sensing chip and the position sensing chip identifies the position of the touch or press operation.

Of course, the coordinate electrodes can be connected to the position sensing chip in other manners by those skilled in the art according to the actual needs. For example, in FIG. 7 which is a schematic view showing a connection of the coordinate electrodes, the plurality of coordinate electrodes 111 may be electrically connected to the position sensing chip after they are connected in a transverse or longitudinal manner Specifically, in FIG. 7, two coordinate electrodes 111 in a transverse direction may be connected to each other via a wire W, and then two coordinate electrodes 111 in a longitudinal direction may be connected to each other via a wire W, so as to form transverse and longitudinal electrodes, and then the transverse and longitudinal electrodes are electrically connected to the position sensing chip via wires, respectively. The connection modes of the coordinate electrodes will not be limited in the embodiments of the present disclosure.

Similar to the coordinate electrodes, in an embodiment of the present disclosure, the pressure electrodes may be independently arranged relative to each other, and the pressure electrodes are electrically connected to the pressure sensing chip, respectively; or the plurality of pressure electrodes are connected to each other and the connected pressure electrodes are electrically connected to the pressure sensing chip. Thus upon a receipt of an external touch or press operation from the pressure electrode the capacitance will be changed and the change value of capacitance may be transmitted to the pressure sensing chip and the pressure sensing chip identifies the pressure magnitude of the touch or press operation.

It should be noted that, since the pressure electrode and the coordinate electrodes are provided independently of each other and are respectively electrically connected to the sensing chips, the change value of capacitance generated on the pressure electrode and the change value of capacitance generated on the coordinate electrodes may be different.

An embodiment of the present disclosure discloses a display device, comprising a pressure sensing panel according to the above embodiments. Reference may be made to the description of the pressure sensing substrate in the above embodiments, which will not be repeated in this embodiment.

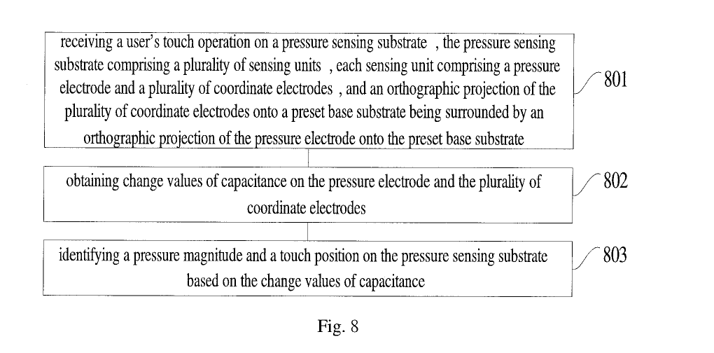

Referring to FIG. 8, it shows a flow chart for showing steps of a pressure detection method according to an embodiment of the present disclosure, the method may include the following steps:

Step 801: receiving a user's touch operation on a pressure sensing substrate, the pressure sensing substrate comprising a plurality of sensing units, each sensing unit comprising a pressure electrode and a plurality of coordinate electrodes, and an orthographic projection of the plurality of coordinate electrodes onto a preset base substrate being surrounded by an orthographic projection of the pressure electrode onto the preset base substrate.

In an embodiment of the present disclosure, the pressure sensing substrate may be applied to various types of terminals, for example, a mobile terminal such as a mobile phone, a tablet computer, a smart watch, and may also be applied to other electronic devices which can be operated by touch, for example, a smart television, a smart telephone. The specific types of the terminal to which the pressure sensing substrate is applied are not limited in the embodiments of the present disclosure.

In an embodiment of the present disclosure, the pressure sensing substrate may be the pressure sensing substrate as described in the above embodiments, and in particular, the pressure sensing substrate may include a plurality of sensing units, each sensing unit may include a pressure electrode and a plurality of coordinate electrodes, and the orthographic projection of the plurality of coordinate electrodes onto the preset base substrate may be surrounded by the orthographic projection of the pressure electrode onto the preset base substrate.

Since the pressure sensing substrate in this embodiment is similar to that of the above embodiments, reference can be made to the above embodiments, and the pressure sensing substrate of this embodiment will not be described again.

Taking a mobile phone in the mobile terminal as an example, when a user performs a touch operation on a display screen of the mobile phone, it is considered that the user performs a touch operation on the pressure sensing substrate mounted in the mobile phone.

Step 802: obtaining change values of capacitance on the pressure electrode and the plurality of coordinate electrodes.

In an embodiment of the present disclosure, the pressure electrode may surround the coordinate electrodes and be disposed independently of the coordinate electrodes, and the pressure electrode and each of the coordinate electrodes may be electrically connected to the corresponding sensing chip, respectively.

In a particular implementation, when a touch operation on the pressure sensing substrate is received from the user, the coordinate electrodes and the pressure electrode on the sensing unit can generate corresponding change values of capacitance, and the pressure sensing chip can timely know the change value of capacitance on the pressure electrode, and accordingly, the position sensing chip can also timely know the change value of capacitance on the coordinate electrodes.

Step 803: identifying a pressure magnitude and a touch position on the pressure sensing substrate based on the change values of capacitance.

In an embodiment of the present disclosure, when the pressure sensing chip and the position sensing chip acquire the change value of capacitance on the pressure electrode and the change values of capacitance on the coordinate electrodes, the pressure magnitude and the touch position on the panel may be further identified based on the change values of capacitance.

In a particular implementation, the position sensing chip may firstly determine a position of the coordinate electrode whose capacitance has changed, thereby identifying the touch position on the pressure sensing substrate according to the position; and then a change value of capacitance on the pressure electrode corresponding to the touch position is determined, thereby the pressure magnitude on the pressure sensing substrate is identified according to the change value of capacitance on the pressure electrode.

In general, the change value of capacitance on the pressure electrode is directly proportional to the pressure magnitude on the pressure sensing substrate, and therefore, the pressure magnitude can be calculated according to the direct proportional relationship between the change value of capacitance on the pressure electrode and the pressure magnitude. The greater the change value of capacitance on the pressure electrode is, the greater the pressure by which a touch or pressure operation is applied to the pressure sensing substrate by the user is. On the contrary, the smaller the change value of capacitance on the pressure electrode is, the smaller the pressure by which a touch or pressure operation is applied to the pressure sensing substrate by the user is.

In the embodiments of the present disclosure, by receiving a user's touch operation on a pressure sensing substrate, and then obtaining change values of capacitance on the pressure electrode and the plurality of coordinate electrodes, a pressure magnitude and a touch position on the pressure sensing substrate can be identified based on the change values of capacitance. In the embodiments of the present disclosure, the coordinate electrodes and the pressure electrode are separately provided, the coordinate electrodes are used to identify the specific position of the press or touch operation, and the pressure electrode is used to identify the pressure magnitude of the press or touch operation. It improves the sensitivity of the pressure sensing, and allows the terminal to achieve different functions according to the different pressure value of the press or touch on the pressure sensing substrate by the user.

It should be noted that, for sake of brevity, the method embodiment is described as a combination of a series of actions. However, it should be appreciated by those skilled in the art that, the embodiments of the present disclosure are not restricted by the sequence of the actions as described. According to the embodiments of the present disclosure, some steps may be performed in other sequence or performed at the same time. In addition, it should be appreciated by those skilled in the art that, all the embodiments described in the specification are only optional embodiments, and the involved actions may not be essential to the embodiments of the present disclosure.

In the present specification, the embodiments are described in a progressive way, so each embodiment is focused on the difference from other embodiments, thus the similar details may be referred to one another among the embodiments.

It should be understood by those skilled in the art that, the embodiments of the present disclosure may be provided as methods, devices or computer program products. Therefore, the embodiments of the present disclosure may take forms of embodiments of mere hardware, mere software, or a combination of software and hardware. Furthermore, the embodiments of the present disclosure may take forms of computer program products executed on one or more computer usable storage media (including but not limited to disk storage, CD-ROM and optical storage, etc.) containing computer usable program codes.

The embodiments of the present disclosure are described with reference to the flowchart and/or a block diagram of the method, the terminal device (system) and a computer program product according to the embodiments of the present disclosure. It should be understood that each process and/or block in the flowcharts and/or block diagrams, and combinations of processes and/or blocks in the flowcharts and/or block diagrams, may be realized by computer program instructions. These computer program instructions may be supplied to a general-purpose computer, a special-purpose computer, an embedded processor, or processors of other programmable data processing terminal devices, to create a machine, such that a device for realizing functions designated in one or more processes in the flowcharts and/or in one or more blocks in the block diagrams, may be produced by instructions performed by a computer or processors of other programmable data processing terminal devices.

These computer program instructions may also be stored in a computer readable storage that can boot a computer or other programmable data processing devices to operate in a specific way, such that a manufactured articles including an instruction device may be produced by the instructions stored in said computer readable storage, and said instruction device realizes the functions designated in one or more processes in the flowcharts and/or in one or more blocks in the block diagrams.

These computer program instructions may further be loaded into a computer or other programmable data processing terminal devices, such that a series of operating steps may be performed on the computer or other programmable data processing terminal devices, so as to generate processes realized by the computer, such that steps for realizing the functions designated in one or more processes in the flowcharts and/or in one or more blocks in the block diagrams may be provided by the instructions executed on the computer or other programmable data processing terminal devices.

Although optional embodiments of the present disclosure have been described, those skilled in the art may make additional alteration and modification to these embodiments once they learn the basic inventive concept. Therefore, the appended claims are intended to be interpreted as covering the optional embodiments and all of the alterations and modifications falling into the scope of the present disclosure.

At last, it should be further noted that, as used herein, relation terms such as “first” and “second” are used merely to distinguish a subject or an operation from another subject or another operation, and not to imply any substantial relation or order between these subjects or operations. Moreover, terms “include”, “contain”, “comprise” or any variation thereof are intended to cover an non-exclusive containing, such that a process, a method, an item or a terminal device containing a series of elements not only includes these elements, but also includes other elements that are not set forth specifically, or also includes an inherent element of such a process, method, item or terminal device. Without further limitation, an element defined by a phrase “include/comprise a . . . ” does not mean that other same elements are excluded from the process, method, item or terminal device.

A pressure sensing substrate, a pressure sensing panel, a display device and a pressure detection method, provided by the embodiments of the present disclosure, are described in detail. The principle and implementation of the embodiments of the present disclosure are set forth with specific examples in the specification. The above description of the embodiments is intended to facilitate understanding of the methods and key idea of the embodiments of the present disclosure. Moreover, for those skilled in the art, based on the idea of the embodiments of the present disclosure, may vary the specific implementation or application. Therefore, the specification should not be interpreted as limitation to the embodiments of the present disclosure.

What is claimed is:

1. A pressure sensing substrate, comprising a plurality of sensing units, each of the sensing units comprising a pressure electrode and a plurality of coordinate electrodes, wherein an orthographic projection of the plurality of coordinate electrodes onto a preset base substrate is surrounded by an orthographic projection of the pressure electrode onto the preset base substrate, and the pressure electrode and the plurality of coordinate electrodes are configured to identify a pressure magnitude and a touch position on the pressure sensing substrate by sensing change values of capacitance on the pressure electrode and the plurality of coordinate electrodes.

2. The pressure sensing substrate according to claim 1, wherein the pressure electrode is disposed in a same layer as the plurality of coordinate electrodes, and the pressure electrode is configured to surround the plurality of coordinate electrodes and the pressure electrode is arranged independently relative to the plurality of coordinate electrodes.

3. The pressure sensing substrate according to claim 1, wherein the pressure electrode is disposed in a different layer from a layer where the plurality of coordinate electrodes are located, and the pressure electrode and the plurality of coordinate electrodes are separated by an insulation layer.

4. The pressure sensing substrate according to claim 1, wherein the coordinate electrodes are rectangular or circular.

5. The pressure sensing substrate according to claim 1, wherein the pressure electrode and the plurality of coordinate electrodes are configured to be driven in a simultaneous manner or in a time-division manner.

6. The pressure sensing substrate according to claim 1, further comprising a plurality of common electrodes, wherein the pressure electrode and the plurality of coordinate electrodes are configured to reuse the plurality of common electrodes.

7. The pressure sensing substrate according to claim 1, wherein each of the sensing units comprises a plurality of pressure electrodes and the plurality of coordinate electrodes.

8. The pressure sensing substrate according to claim 1, wherein the coordinate electrodes are configured to identify the touch position on the pressure sensing substrate, and the pressure electrode is configured to identify the pressure magnitude on the pressure sensing substrate.

9. A pressure sensing panel, comprising the pressure sensing substrate according to claim 1.

10. The pressure sensing panel according to claim 9, wherein the coordinate electrodes on the pressure sensing substrate are independently arranged relative to each other, and
the coordinate electrodes are electrically connected to a position sensing chip, respectively; or the plurality of coordinate electrodes are connected to each other and the connected coordinate electrodes are electrically connected to the position sensing chip.

11. The pressure sensing panel according to claim 9, wherein the pressure electrodes on the pressure sensing substrate are independently arranged relative to each other, and
the pressure electrodes are electrically connected to a pressure sensing chip, respectively; or the plurality of pressure electrodes are connected to each other and the connected pressure electrodes are electrically connected to the pressure sensing chip.

12. The pressure sensing panel according to claim 10, wherein the pressure electrodes on the pressure sensing substrate are independently arranged relative to each other, and
the pressure electrodes are electrically connected to a pressure sensing chip, respectively; or the plurality of pressure electrodes are connected to each other and the connected pressure electrodes are electrically connected to the pressure sensing chip.

13. A pressure sensing panel, comprising the pressure sensing substrate according to claim 2.

14. A pressure sensing panel, comprising the pressure sensing substrate according to claim 3.

15. A pressure sensing panel, comprising the pressure sensing substrate according to claim 4.

16. A pressure sensing panel, comprising the pressure sensing substrate according to claim 5.

17. A display device, comprising the pressure sensing panel according to claim 9.

18. A pressure detection method, comprising steps of:
receiving a user's touch operation on a pressure sensing substrate, the pressure sensing substrate comprising a plurality of sensing units, each sensing unit comprising a pressure electrode and a plurality of coordinate electrodes, and an orthographic projection of the plurality of coordinate electrodes onto a preset base substrate being surrounded by an orthographic projection of the pressure electrode onto the preset base substrate;
obtaining change values of capacitance on the pressure electrode and the plurality of coordinate electrodes; and
identifying a pressure magnitude and a touch position on the pressure sensing substrate based on the change values of capacitance.

19. The method according to claim 18, wherein the step of identifying the pressure magnitude and the touch position on the pressure sensing substrate based on the change values of capacitance comprises:
determining a position of the coordinate electrode whose capacitance has changed;
identifying the touch position on the pressure sensing substrate according to the position;
determining a change value of capacitance on the pressure electrode corresponding to the touch position; and
identifying the pressure magnitude on the pressure sensing substrate according to the change value of capacitance on the pressure electrode.

20. The method according to claim 19, wherein the step of identifying the pressure magnitude on the pressure sensing substrate according to the change value of capacitance on the pressure electrode comprises:
calculating the pressure magnitude according to a direct proportional relationship between the change value of capacitance on the pressure electrode and the pressure magnitude.
